(19) United States
(12) Patent Application Publication
(10) Pub. No.: US 2010/0104132 A1
(43) Pub. Date: Apr. 29, 2010

(54) COMPUTER IMAGE PROCESSING SYSTEM AND METHOD FOR NDT/NDI TESTING DEVICES

(76) Inventor: Ehab GHABOUR, Northborough, MA (US)

Correspondence Address: OSTROLENK FABER GERB & SOFFEN, 1180 AVENUE OF THE AMERICAS, NEW YORK, NY, 100368403, US

(21) Appl. No.: 12/605,716

(22) Filed: Oct. 26, 2009

Related U.S. Application Data
(60) Provisional application No. 61/108,251, filed on Oct. 24, 2008.

(51) Int. Cl. G06K 9/00; G09G 5/00

(52) U.S. Cl. 382/100; 345/619

(57) ABSTRACT

A system and method suitable for producing color images of signals received from flaw detection devices with high efficiency that allow accurate image processing in real time by making use of a commercially available graphics accelerator and associated software. An exemplary S-scan scanned area is mapped into vertex coordinates and primitives to create a surface. The surface is then given a color texture representing S-scan signal amplitude information. An efficient commercially available graphics accelerator is used to render color image efficiently based the input of the vertex coordinates, primitives and the color texture.

### CROSS REFERENCE TO RELATED APPLICATIONS

The present application claims the benefit of U.S. Provisional Patent Application No. 61/108,251 filed on Oct. 24, 2008, which is incorporated herein by reference in its entirety.

### FIELD OF THE DISCLOSURE

The present disclosure generally relates to an improved image processing system and method for ultrasonic non-destructive test and inspection (NDT/NDI) devices, more particularly, to an image processing system and method that uses a hardware graphics accelerator and software to provide high performance image rendering of NDT/NDI measurement signals.

### BACKGROUND OF THE DISCLOSURE

NDT/NDI devices, such as ultrasonic test instruments, have been used in industrial applications for more than sixty years. They are widely used for flaw detection to find hidden cracks, voids, porosity, and other internal discontinuities in solid metals, composites, plastics, and ceramics, as well as to measure thickness and analyze material properties.

Ultrasonic phased array NDT/NDI instruments provide a significant advantage for flaw detection because they display a cross section of the region being inspected, thereby faciltating the visualization of the flaw within the inspected material and the estimation of its location and size. If an appropriate phased array probe exists, it is well known to those skilled in the art that an S-scan measurement is preferable for conducting inspections because it enables the inspector to see a virtual two dimensional region inside of the test material rather than a single point, as is provided by an A-scan measurement.

An S-scan is comprised of a series of contiguous A-scans that are applied and measured at different focal laws. For example, for an S-scan covering a 30 degree sector from 30 to 60 degrees in 1 degree increments, the instrument sets the first focal law to 30 degrees, takes an A-scan measurement, then proceeds to do the same from 31 to 60 degrees in 1 degree steps. The signal data from multiple beams are then combined to make an S-scan image.

There are also other known ultrasonic scan image types, such as C-scan and Linear scan that are generated by phased array instruments.

The challenges of presenting these scan images generated by phased array instruments are: 1) a large number of software calculations must be performed to represent an irregular geometric shape by a mesh that maps the screen pixels, 2) the ultrasonic signal amplitudes must be meshed in real time, 3) the amplitude of the regions between the mesh points must be determined by interpolation, or other method, to fill in the mesh, 4) a powerful high speed processor is required to produce the S-scan images in real time, and, 5) each time the user changes the setup for the S-scan sector range of angles, the entire mesh needs to be recalculated which is very computational intensive—e.g. a 30 to 60 degree sector is changed to a 20 to 50 degree sector.

Existing solutions address these challenges with a much more hardware and software intensive solution than the embodiments of the present disclosure.

In the existing phased array products, the S-scan image area is divided into a mesh that maps the pixels of a display screen. Typically, display screens for portable phased array products have at least 307, 200 pixels (i.e. 640×480 VGA resolution). The S-scan surface usually takes about 40% of the screen area, which occupies about 120,000 pixels; therefore, the size of the mesh contains about 120,000 pixels. The background art uses a computationally intensive process to create the matrix required to map the appropriate amplitude color to each of the 120,000 pixels of each S-scan. The process is executed by means of digital hardware controlled in fine granularity by software, and is particularly cumbersome due to the need for the S-scan surface to be created every time the image is updated on the display.

The challenges of implementing the background art are also significant because the programmers of ultrasonic imaging systems are not typically experts on computer graphics programming, and a significant amount of software and digital hardware design is required.

The embodiments of the present disclosure are intended to address several challenges associated with generating real time scan images, such as S-scan, Linear scan and C-scan images and to overcome the shortcomings of existing solutions as described above.

### SUMMARY OF THE INVENTION

The invention disclosed herein solves the problems related to presenting color image of ultrasonic inspection signals in real time, particularly for scanned area and defects having irregular shapes, whereas the existing methods present the aforementioned drawbacks, such as demanding computation consumption, lack of accuracy in representation of geometric characteristic and ultrasonic data and complicated programming process, etc.

Accordingly, it is a general object of the present disclosure to provide a method and a system suitable for producing color images of signals received from flaw detection devices with high efficiency that allow accurate image processing in real time by making use of a commercially available graphics accelerator and associated software.

It is further an object of the present disclosure to accurately represent the geometric characteristic of both the test object and the flaws of irregular shapes within it.

It is further another object of the present disclosure to accurately map the ultrasonic S-scan signal measurements in amplitude, or gated amplitude, with the geometric representation of the flaws and the test object in real time.

It is further another object of the present disclosure to, by using an efficient commercially available computer graphics accelerator to produce the display image in real time by filling in the accurate color at the correct pixel locations.

Advantages the present disclosure provides include to display colored S-scan image in real time without the need for programmers to write complex software code as it is needed in existing solutions to create a matrix that maps ultrasonic signal amplitudes to specific pixels onto the display;

Advantages the present disclosure provides further include the elimination of the need of re-execute the image processing software code for each S-scan as it is needed in existing solutions to fill a matrix with ultrasonic signal amplitudes, thus significantly improving the efficiency of imaging processing;

And lastly, advantages the present disclosure provides further include that it allows the usage of commercially available high performance graphics accelerator to produce high quality images in real time with simplified coding.

The foregoing and other objects, advantages and features of the present invention will become more apparent upon reading of the following non restrictive description of illustrative embodiments, given for the purpose of illustration only with reference to the appended drawings.

### BRIEF DESCRIPTION OF THE DRAWINGS

FIG. 1 shows an ultrasonic S-scan Surface with established vertexes, primitives and vertex coordinates.

FIG. 2 is an ultrasonic A-scan signal showing the change of echo signal amplitude as a function of time.

FIG. 3 is the Color Texture Map consisting of color value bars onto which the amplitude data of signals are mapped according to a color palette.

FIG. 4 shows the process of creating a Texture for the Surface with color values corresponding to A-scan signal amplitudes.

FIG. 5 is a representative view of the disclosed image processing system comprising functional modules.

FIG. 6 is a function block diagram for the Surface Generator Module.

FIG. 7 is a function block diagram for the Texture Generator Module.

FIG. 8 is a function block diagram for the Image Rendering Module.

### DETAILED DESCRIPTION OF THE PRESENT DISCLOSURE

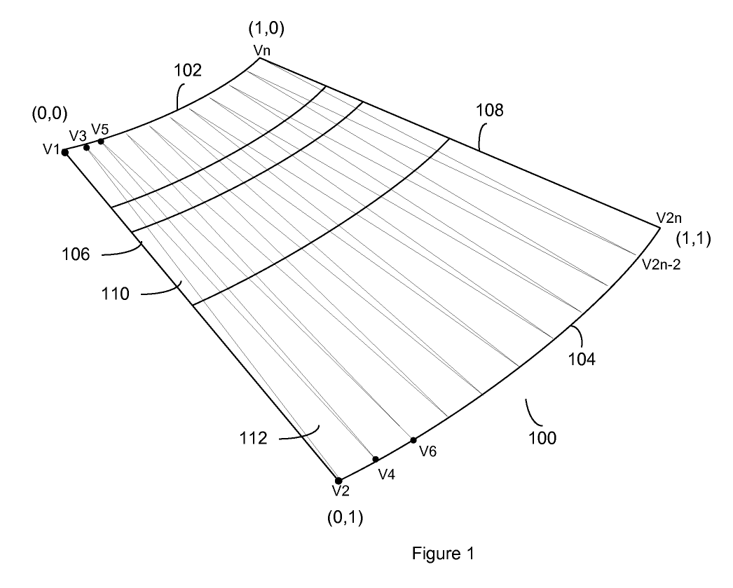

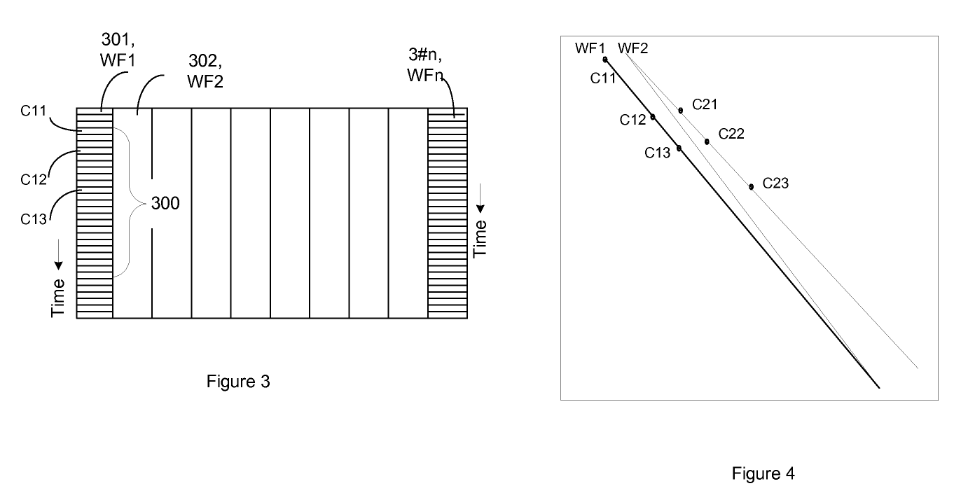

Referring to FIG. 1, the contour and location of Surface 100 is created in order to plot the S-scan colorized measurement data within it before providing the image to the display. This is accomplished by mapping all of the coordinates of Surface 100 to an equivalent set of coordinates associated with the Color texture Map of FIG. 3, but spatially different. It should be noted that the spatial placement of the coordinate points for Surface 100 is for a curved two dimensional surface; whereas, the Color texture Map is for a rectangular surface.

One of the principal objectives of the embodiments of the present disclosure is to efficiently map the texture information in the Color texture Map to Surface 100, then determine the color for the pixels located between the coordinate values by means of interpolation performed by a graphics accelerator, and lastly render the S-scan image on the display in real time. The means to accomplish this is described in detail below.

There are many factors affecting the ultrasonic signal amplitude and travel paths inside a solid material that need to be considered when forming an S-scan image. The book publication by RD Tech, Inc. “Introduction to Phased Array Ultrasonic Technology Applications”—Advanced Practical NDT Series, Chapter 3, teaches the theory and steps that can be used to create the acoustic events that provide the foundation for the Surface 100 and the resulting S-scan image. The book reference herein mentioned also describes the factors affecting the size and shape of the Surface as listed below.

Probe Parameters:
Frequency of ultrasonic signals;
Bandwidth of the ultrasonic signals;
Size of the probe;
Number of elements;
Element pitch.

Wedge Parameters
Incident angle of the wedge;
Nominal sound velocity of the wedge;
Height to center of first element;
Distance from front of wedge to first element;
Distance from side of wedge to center of elements;

Other Required User inputs:
Material sound velocity;
Element Quantity (the number of elements used to form the aperture of the probe);
First element to be used for scan;
The last element in the electronic raster;
Element step (defines how defined aperture moves across the probe);
Desired focus depth, which must be set less than near field length (N) to effectively create a focus;
Angle of inspection.

As mentioned earlier, when phased array elements are fired multiple times with sequentially changing angles, the received A-scan signals are recorded for each firing. With further reference to FIG. 1, the contour of Beginning Line 102 represents the beginning point of the A-scan signals to be viewed and the contour of Ending Line 104 represents the end of the A-scan signals to be viewed. First Angle Line 106 represents the first focal angle at which the elements are fired. The Last Angle Line 108 represents the last focal angle at which the elements are fired.

An aspect of this invention derives from the fact that it includes the steps of determining: 1) how to divide Surface 100 into fixed geometric shapes, know as primitives, 2) how to give the Surface a texture by mapping the colorized signal information onto Surface 100, and 3) how to make use of a graphics accelerator to generate the ‘texture’ image efficiently on an electronic display.

Surface 100 is divided into a plurality of simple shapes such as triangles. Referring to FIG. 1, a plurality of vertexes is defined along Beginning Line 102 and Ending Line 104. The total number of inner vertexes and outer vertexes are chosen depending on the requirement for image accuracy and speed to have images updated on the display. The higher the accuracy, the lower the image updating speed and higher the number of vertexes. The coordinates associated with the vertexes for each primitive are stored in memory location called a vertex buffer.

Once the total number of vertexes on Beginning Line 102 or Ending line 104, n, is determined, Line 102 and 104 are each divided into (n−1) equal segments, which are indicated in FIG. 1 as line sections V₁-V₃, V₃-V₅, . . . , and Vₙ₋₁-Vₙ and V₂-V₄, V₄-V₆, . . . , V₂ₙ₋₂-v₂ₙ. It should be noted that n=11 in the exemplary embodiment shown in FIG. 1.

Next, triangles are drawn using the vertexes on the Beginning Line 102 and the Ending Line 104 to divide the whole of Surface 100. For example, V₂V₁V₃ forms one triangle. V₂V₄V₃ forms the second triangle. . . . , and V₂ₙ₋₂V₂ₙVₙ forms the last triangle. There are a total of 2n triangles in the exemplary embodiment; the texture surface coordinates for each being stored in their respective vertex buffer.

Also shown in FIG. 1 is the perimeter region of Surface 100 defined by the connecting points of lines 102, 106, 104 and 108 which are assigned texture surface coordinates, (0, 0), (0,1), (1,0) and (1,1). The contents of the vertex buffers are mapped to the surface coordinates contained within the perimeter region. Any point on Surface 100, including all the vertexes, can be given a specific coordinates accordingly.

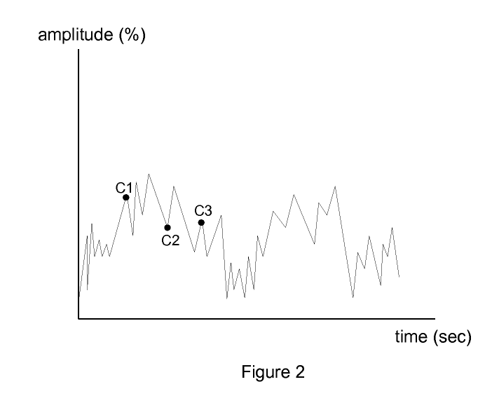

When the test probe is pulsed at sequentially changing focal laws, the ultrasonic signal response is recorded and mapped onto a corresponding triangle in FIG. 1. Referring to FIG. 2, a signal is recorded after the probe is fired at the focal law corresponding to triangle V₂V₁V₃. The X-Axis is time in seconds and the Y-Axis is the % of maximum amplitude.

Referring to the Color Texture Map of FIG. 3, the first triangle primitive, defined by V₂V₁V₃, is drawn corresponding to Color Value Bar 301, and the second triangle primitive, defined by V₂V₄V₃, is drawn corresponding to Color Value Bar 302. All triangle primitives in FIG. 1 are mapped to their respective Color Value Bars in FIG. 3, the cell values of which were determined by the signal amplitude measurements for each respective A-scan.

The time line of a signal is represented by sequence from the top to the bottom of Color Value Bar 301. Color Value Bar 301 is divided into a plurality of color data cells 300, which are filled with the amplitude measurement information for the first A-scan signal (WF1). The number of color data cells 300 varies depending on the desired level of performance and accuracy of the image process. For the disclosed embodiment, 256 color data cells are used.

Referring to Table 1, a color palette look up table is used to determine the corresponding values of each color data cell 300. For example, A-scan signal amplitude C₁ in FIG. 2 corresponds to data cell C₁₁ in FIG. 3, which corresponds to a color value of 36317 in the color palette look up table. A-scan signal amplitude C₂ in FIG. 2 corresponds to data cell C₁₂ in FIG. 3, which corresponds to a color value of 48830.

By using this method, the amplitudes of A-scan signal in FIG. 2 can be given a series of color values that are stored and assigned to corresponding Color Value Bar 031 in FIG. 3. Accordingly, every A-scan response signal sequentially fired can be mapped to the corresponding Color Value Bars 301 to 3#n in FIG. 3.

TABLE 1
Part of a Typical Color Value Look-Up
Table for Ultrasonic Imaging

| Amplitude % | In 0-255 Scale | Color Value (in RGB 565 System) |
|---|---|---|
| 6 | 16 | 48830 |
| 6 | 17 | 48830 |
| 7 | 18 | 46750 |
| 7 | 19 | 44702 |
| 7 | 20 | 44670 |
| 8 | 21 | 42590 |
| 8 | 22 | 42590 |
| 9 | 23 | 40510 |
| 9 | 24 | 40477 |
| 9 | 25 | 38429 |
| 10 | 26 | 38397 |
| 10 | 27 | 36349 |
| 10 | 28 | 36317 |
| 11 | 29 | 34237 |
| 11 | 30 | 34237 |
| 12 | 31 | 32157 |
| 12 | 32 | 32125 |

As shown in FIG. 4, the mapped Color Value Bars (301 through 3#n) are then used to give Surface 100 a Texture. Color value cells 300 are comprised of a contiguous series of cells, each containing a value corresponding to the predetermined color associated with an A-scan amplitude measurement.

For example, color values C₁₁, C₁₂, C₁₃ of Color Value Bar 301 are mapped onto line V₁V₂ of FIG. 1 as C₁₁, C₁₂, C₁₃, respectively, with the same A-scan time line going from the top to the bottom of Color Value Bar 301 and from V₁ to V₂. Accordingly, color values corresponding to the amplitudes of each signal point along each A-scan are sequentially mapped to connecting vertexes throughout Surface 100.

Upon completion of this process, the entirety of Surface 100 is then given a Texture comprised of the color values associated with A-scan amplitudes of FIG. 3, and the interpolated colors between each of A-scan point and the corresponding point in time on the next adjacent A-scan comprising the S-scan. The texture color values are mapped to all pixels within the two dimensional sector region demarcated by the perimeter lines connecting coordinates (0, 0), (0, 1), (1, 0), (1, 1) in FIG. 1. It should be noted that the color texture values between each A-scan need not be determined by interpolation, but may be set to a fixed color.

In an alternate embodiment, the amplitude of the signals can be directly applied to the texture without the need for a look up table as described previously. This is because some graphics accelerator tools can directly map values of amplitude to custom-color palette.

The basic steps of how to render of surfaces any size and shape into primitives and how to give a surface textures are illustrated in details in a book “Real Time rendering in DirectX” by Kelly Dempski”, published by Premier Press, in pages 134, 135, 136, 137, 138, 194, 195 and 196.

With the established surface, vertex coordinates, vertex buffers, and color textures as input, a graphics accelerator can be used to render colored image very efficiently. For example, the graphics accelerator provides the corresponding colors on the screen at corresponding locations at data points for C₁, C₂, C₃, . . . according to color data values C₁₁, C₁₂, C₁₃, . . . , respectively. The graphics accelerator fills in the pixels in between data points using an algorithm selected from the supported algorithms in the graphics accelerator, some of which provide different types of interpolation, such as linear and second order. Image smoothing can also be provided by selecting a different interpolation algorithm for the graphics accelerator.

In the last step, the Surface Texture is provided to a graphics accelerator so that S-scan measurement image can be rendered and presented on a display very efficiently.

The solutions used for the background art, in this regard, are much less efficient because they need to calculate, interpolate and render the color matrix in real time for every S-scan screen image update without the aid of a commercially available graphics accelerator and a graphics software API. Use of a commercially available graphics accelerator and a graphics software API, instead of a custom proprietary designed solution, reduce considerably the time it takes to design the graphics system solution, and the complexity of the resulting hardware and software design solution is also reduced.

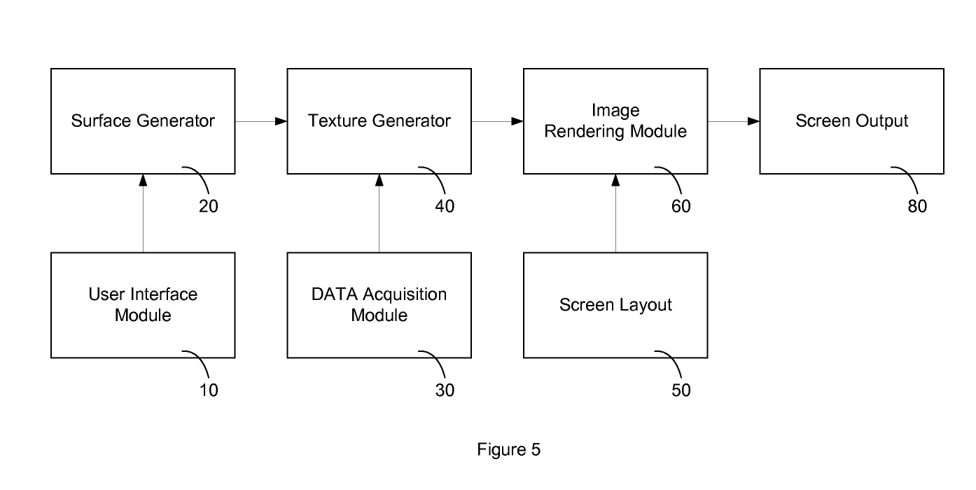

The aforementioned process is executed by the preferred embodiment of the present disclosure in the following way. Referring to FIG. 5, the image processing system is comprised of a User Interface Module 10, a Surface Generator 20, a Data Acquisition Module 30, Texture Generator 40, Screen Layout Module 50, Image Rendering Module 60 and Screen Output 80.

Test setup information, including parameters about the wedge, probe and target material, are provided to Surface Generator 20 by means of User Interface Module 10. User Interface Module 10 is a keypad or remote control signals provided to the NDT/NDI device. The surface vertexes and texture coordinates for Surface 100 are generated by the Surface Generator 20. Measurement results are acquired in real time by Data Acquisition Module 30 and subsequently provided to Texture Generator 40. Texture Generator 40 gives the Surface 100 a Texture in real-time based on the amplitude of the A-scan input signal and its corresponding color value mapped onto the vertex and texture coordinates generated by Surface Generator 20. Next, with input of the Surface parameters from the Surface Generator 20 and the Texture from Texture Generator 40, Image Rendering Module 60 maps the Texture with the Surface 100, and further maps the Textures with screen pixels and produce colored, real-time test image to the Screen Output 80.

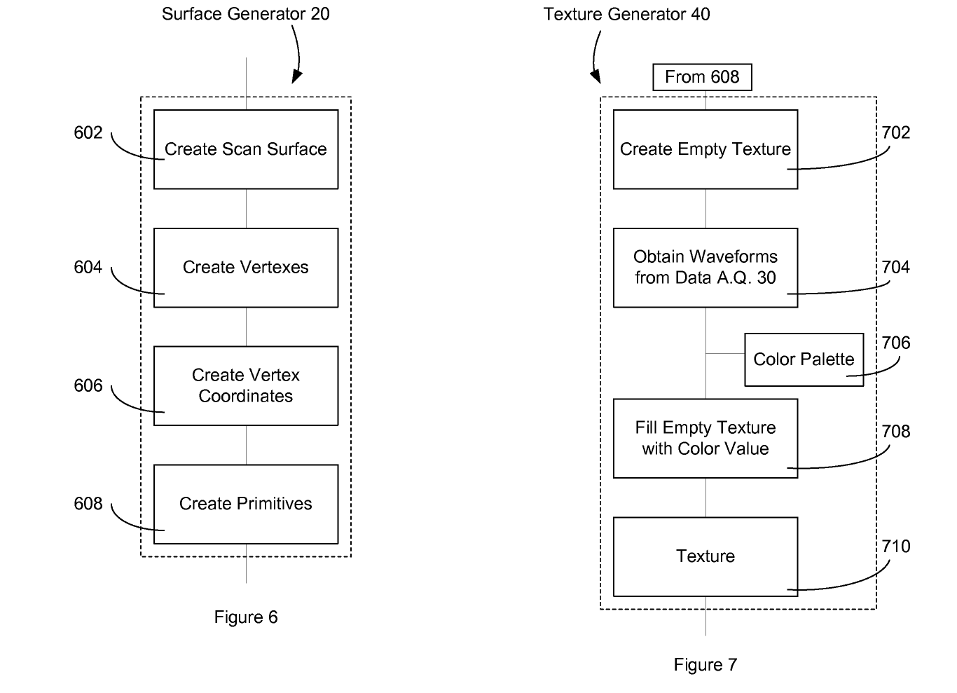

Referring further to the process for creating Surface 100 described above and in FIG. 6, plotting of Surface 100 is executed in Surface Generator 20. User Interface Module 10 in FIG. 5 is used to provide the input information about a flaw testing session into the Surface Generator 20. At 602, a Surface representing the size and shape of the test signal paths is plotted. At 604, Vertexes are created. At 606, vertex coordinates are created throughout the whole Surface 100. At 608, Primitives are created to divide the whole Surface 100.

Referring to the process for generating a Texture on top of Surface 100 described above for FIG. 5, Data Acquisition Module 30 acquires response signal data from the flaw detector phased array probe and provides it into Texture Generator 40. Texture Generator 40 then gives Surface 100 a Texture by mapping the measurement amplitude data onto Surface 100. Referring to FIG. 7, within Texture Generator 40, an empty Texture is first generated at 702. Then at 704, Texture Generator 40 obtains response signal from the Data Acquisition Module 30. At 708, color Texture representing data from each A-scan signal is created by matching data on each response signal with color value found in the color palette 706. At 708, after all the signals with sequentially fired focal law angles are mapped with color value, the color values are then mapped onto created Primitives. Then, a Texture of Surface 100 is generated at 710.

Alternatively, one can use a configurable color palette available in the graphics accelerator, which eliminates the coding process for color-to-amplitude mapping.

The last step for image rendering occurs when Surface 100 and its Texture are provided to the graphics accelerator of Image Rendering Module 60 to render the display image. In this disclosed embodiment, DirectX is used to configure Image Rendering Module 60.

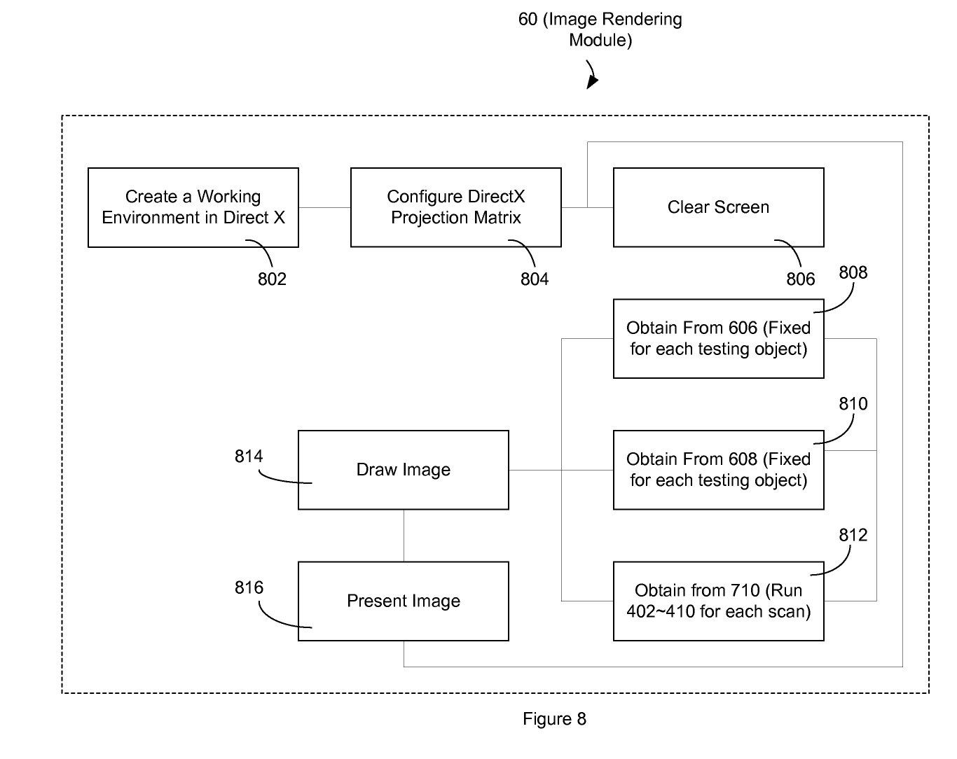

A functional block diagram of the Image Rendering Module 60 is shown in FIG. 8. Within the Image Rendering Module 60, a working environment is created in DirectX at 802. Then a projection matrix is configured in the graphics accelerator at 804. At 806, the screen image is cleared from a previous display session. Then, Vertex Coordinates of 606 are obtained at 808, Primitives of 608 are obtained from Surface Generator 20 at 810, and Texture of 710 is obtained from Texture Generator 40 at 812. Combining the above input, at 814, the S-scan is provided to Screen Output 80 of FIG. 5.

In practice, once a testing session is set up for a test object, routines in Surface Generator 20 (602-608) do not need to be changed for each scan. Similarly, configuration steps for DirectX do not need to be changed either. When a new scan is performed and the new response signal is provided to Texture Generator 40, Texture Generator 40 only needs to update the new signal data generate a new Texture. That is, only routines in Texture Generator 704-710 in FIG. 7, and routines of 808-816 in FIG. 8 need to be re-run to update the image for each new scan.

Accordingly, the efficiency is significantly improved in comparison to background art methods which need to execute the calculating, interpolating and rendering the whole color matrix every time an S-scan image is provided to the display during an active measurement. In addition, none of the existing method makes use of a high performance graphics accelerator.

Although the present invention has been described in relation to particular embodiments thereof, many other variations and modifications and other uses will become apparent to those skilled in the art. For example, such variation might include but not limited to using the presently disclosed method to produce color images of inspection signals generated by other type of NDT/NDI instruments. It is preferred, therefore, that the present invention be limited not by the specific disclosure herein, but only by the appended claims.

What is claimed is:

1. A computer processing method suitable for producing colored representations of ultrasonic signals reflected from a scanned area of a test object being inspected by an ultrasonic inspection device, wherein the scanned area includes possible defects, the method comprising the steps of:
creating a surface to match the scanned area;
meshing the surface into a plurality of primitives having predetermined geometric shapes;
converting the ultrasonic signals to a set of corresponding colorized signal data;
creating a texture for the surface by mapping the colorized signal data onto the corresponding primitives;
providing the surface, the primitives and the corresponding texture as an input to a computer graphics accelerator program; and
executing the graphics accelerator program to produce the colored representation of the ultrasonic signals reflecting spatial characteristics of the defects and the scanned area on an electronic display.

2. The method of claim 1, wherein producing the colored representation is carried out in real time as ultrasonic signals are obtained by the inspection device.

3. The method of claim 1, wherein the ultrasonic signals is provided in a format of S-scan by the inspection device.

4. The method of claim 1, wherein the ultrasonic signals are provided in a format of C-scan by the inspection device.

5. The method of claim 1, wherein the ultrasonic signals are provided in a format of Linear scan by the inspection device.

6. The method of claim 1, wherein the inspection device are a phased array ultrasonic inspection device.

7. The method of claim 1, wherein the scanned area is of a two dimensional, thin layered shape residing on and/or within the test object.

8. The method of claim 1, wherein the scanned area is of an irregular shape.

9. The method of claim 1, wherein the color representations are configured to present an image of flaws and spatial characteristic of the scanned area of the test object.

10. The method of claim 1, wherein the step of meshing the surface into a plurality of primitives further comprise the steps of,
creating vertexes over the surface;
creating vertex coordinates for the vertexes; and
creating the primitives based on the vertexes.

11. A computer processing system used in conjunction with an ultrasonic inspection device, suitable for producing colored representation of ultrasonic signals reflected from a scanned area of a test object, wherein the scanned area includes possible defects, the system comprising:
a surface generator creating a surface by matching the scanned area and meshing the surface into a plurality of primitives having predetermined geometric shapes;
a texture generator converting the ultrasonic signals to a set of corresponding colorized signal data and creating a texture for the area by mapping the colorized signal data onto the corresponding primitives; and
an image rendering module using the surface, the primitives and the corresponding texture as input to a computer graphics accelerator program and, by executing the graphics accelerator program, producing the colored representation of the ultrasonic signals reflecting spatial characteristics of the defects and the scanned area on an electronic display.

12. The system of claim 11, wherein producing the colored representation is carried out in real time as ultrasonic signals are obtained by the inspection device.

13. The system of claim 11, wherein the ultrasonic signals are provided in a format of S-scan by the inspection device.

14. The method of claim 11, wherein the ultrasonic signals are provided in a format of C-scan by the inspection device.

15. The method of claim 11, wherein the ultrasonic signals are provided in a format of Linear scan by the inspection device.

16. The system of claim 11, wherein the inspection device is a phased array ultrasonic inspection device.

17. The system of claim 11, wherein the scanned area is of a two dimensional, thin layered shape residing on and/or within the test object.

18. The system of claim 11, wherein the scanned area is of an irregular shape.

19. The system of claim 11, wherein the color representation is configured to present an image of flaws and spatial characteristic of the scanned area of the test object.

20. The system of claim 11, wherein the surface generator creates vertexes over the surface and further creates vertex coordinates for the vertexes and yet further creates the primitives based on the vertexes.
